(19) United States
(12) Patent Application Publication
(10) Pub. No.: US 2026/0241520 A1
(43) Pub. Date: Aug. 20, 2026

(54) HIGH-PRECISION DIGITAL-DISPLAY TORQUE WRENCH

(71) Applicant: Bobby Hu, Taichung City (TW)

(72) Inventor: Bobby Hu, Taichung City (TW)

(21) Appl. No.: 19/171,534

(22) Filed: Apr. 7, 2025

(30) Foreign Application Priority Data
Jan. 23, 2025 (TW) 114103129

(51) Int. Cl. B25B 23/142; B25B 23/14

(52) U.S. Cl. CPC B25B 23/1425; B25B 23/141; B25B 23/1427

(57) ABSTRACT

A high-precision digital-display torque wrench includes a main body; a wrenching device pivotally disposed on the main body; a torque release device pivotally disposed in the main body and optionally abutting against the wrenching device; a resilient member with one end fixed to the torque release device; a torque adjustment device with a sliding seat slidably movable along a direction parallel to an axis of the main body; a fine adjustment device disposed on the sliding seat and having a supporting member on which another end of the resilient member rests and a fine adjustment member, the fine adjustment member fine adjustably supporting the supporting member, so as to fine adjust a force with which the torque release device rests on the wrenching device; and a torque sensing device displaying a torque setting value according to a displacement change of the sliding seat.

### BACKGROUND OF THE DISCLOSURE

### 1. Field of the Disclosure

The present disclosure relates to torque wrenches, and more particularly, to a high-precision digital-display torque wrench.

### 2. Description of the Related Art

Referring to the patent U.S. Pat. No. 11,279,009B2, a Torque Wrench is disclosed, which is a torque wrench digitally displaying the torque value setting. The torque wrench comprises a main body, a driving part, a disengagement mechanism, a torque assembly, and an adjustment assembly. The torque assembly has a biasing member and an abutting member. The adjustment assembly comprises a position limiting member, an adjustment member, and a sliding assembly. The position limiting member abuts against the biasing member. The sliding assembly is fixed to the position limiting member and slidably disposed within the main body. The adjustment member adjusts the sliding assembly, so as to adjust the relative position of the position limiting member abutting against the biasing member. Therein, when the torque born by the driving part is larger than the preset torque value of the torque wrench, the disengagement mechanism and the abutting member are disengaged, thereby signaling the user that the torque value for fastening the fastener has reached the preset value.

However, the base of the aforementioned torque wrench comprises a guiding slit for limiting the movement of the sliding assembly, wherein the axial length of the guiding slit directly determines the maximum travel distance of the sliding assembly, thus limiting the adjustment range of the torque value. Furthermore, during the production process, the processing precision of the guiding slit of the base and the assembly tolerances of related components affect the accuracy of the torque value, resulting the difficulty of achieving a precise calibration before the product leaves the factory. Such limitations prevent the torque wrench from fully meeting the requirements of high-precision torque tools in the related fields.

### SUMMARY OF THE DISCLOSURE

To improve the issues above, the present disclosure provides a high-precision digital-display torque wrench. By fine adjusting the force with which the torque release device abuts against the wrenching device through the fine adjustment device, the torque setting value is precisely adjusted, so that the torque value range of the high-precision digital-display torque wrench is fine adjusted to the predetermined position before the torque wrench leaves the factory, fulfilling the usage requirement of high-precision tools.

For achieving the aforementioned objectives, an embodiment of a high-precision digital-display torque wrench in accordance with the present disclosure comprises:
a main body having a first end and a second end away from the first end arranged along an axis, with a housing space formed between the first end and the second end;
a wrenching device pivotally disposed at the first end and having a wrenching end exposed from the main body;
a torque release device pivotally disposed in the housing space and optionally abutting against one end of the wrenching device away from the wrenching end;
a resilient member disposed in the housing space in a manner not parallel to the axis, the resilient member having a fixed end and a contact section away from the fixed end, the fixed end fixed to the torque release device;
a torque adjustment device disposed on the main body and having a sliding seat, the sliding seat disposed in the housing space and slidably movable along a direction parallel to the axis;
a fine adjustment device disposed on the sliding seat, the fine adjustment device having a supporting member on which the contact section of the resilient member rests and a fine adjustment member, the fine adjustment member fine adjustably supporting the supporting member, so as to fine adjust a force with which the torque release device rests on the wrenching device; and
a torque sensing device disposed on the main body corresponding to the torque adjustment device, the torque sensing device displaying a torque setting value according to a displacement change of the sliding seat.

With such configuration, the present disclosure uses the fine adjustment device to fine adjust the force with which the torque release device rests on the wrenching device, so as to adjust the precision of the torque setting value, effectively preventing the torque value deviation caused by manufacturing tolerances, assembly errors, and other factors, thereby ensuring that the torque setting of the wrench achieves a low-error range, providing consumers with high-precision wrench products.

### BRIEF DESCRIPTION OF THE DRAWINGS

FIG. 1 is a perspective view of the high-precision digital-display torque wrench in accordance with an embodiment of the present disclosure.

FIG. 2 is an exploded view of the high-precision digital-display torque wrench in accordance with an embodiment of the present disclosure.

FIG. 3 is a cross-sectional view taken along line A-A in FIG. 1, illustrating the wrenching member indirectly contacting the main body through a plurality of contact members.

FIG. 4 is a cross-sectional view taken along line B-B in FIG. 1, illustrating the lock device at the locked position.

FIG. 5 is a cross-sectional view taken along line C-C in FIG. 1, illustrating the sliding seat positioned away from the stopper, with the torque setting value set to the minimum.

FIG. 6 is a partially enlarged view of FIG. 5.

FIG. 7 is a schematic view of wrenching motion of the high-precision digital-display torque wrench, illustrating the releasing member disengaged from the press member.

FIG. 8 is a longitudinal sectional view of the high-precision digital-display torque wrench, illustrating the lock device at the unlocked position.

FIG. 9 is a transverse sectional view of the high-precision digital-display torque wrench, illustrating the sliding seat abutting against the stopper, with the torque setting value set to the maximum.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion. Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

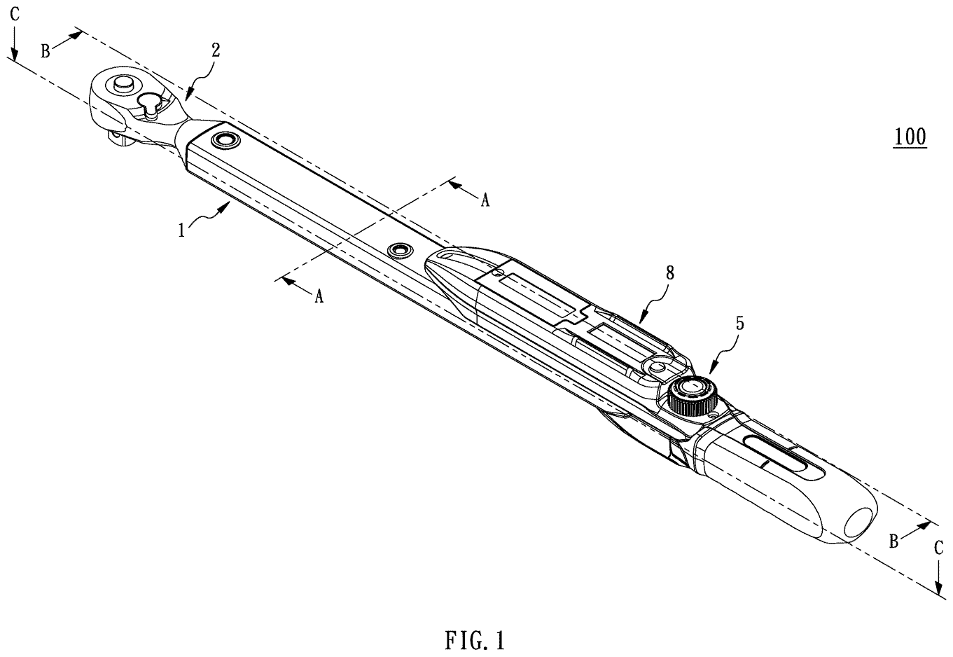

Referring to FIG. 1 to FIG. 9, the present disclosure provides an embodiment of a high-precision digital-display torque wrench 100, comprising a main body 1, a wrenching device 2, a torque release device 3, a resilient member 4, a torque adjustment device 5, a fine adjustment device 6, a lock device 7, and a torque sensing device 8.

The main body 1 is formed of an aluminum alloy material. The main body 1 has a first end 10 and a second end 11 away from the first end 10 along an axis L1 defined by the main body 1. The axis L1 divides the main body 1 into a forward side LF and a reverse side LR. A housing space 12 is formed between the first end 10 and the second end 11. The main body 1 is in a flat rectangular hollow tube shape, with a guidance part 121 disposed in the housing space 12. The main body 1 has a first pivot hole 13, a second pivot hole 14, and a third pivot hole 15 sequentially disposed thereon from the first end 10 toward the second end 11, wherein the first pivot hole 13, the second pivot hole 14, and the third pivot hole 15 are in communication with the housing space 12. Also, the main body 1 has an elongate sensing hole 16 disposed in adjacent to the second end 11 and in communication with the housing space 12. Therein, the housing space 12 has an inner wall 122 therein. The inner wall 122 has a first inner wall 122a on the reverse side LR and a second inner wall 122b on the forward side LF.

The wrenching device 2 is pivotally disposed at the first end 10 of the main body 10, and comprises a wrenching end 2a exposed from the main body 1. The wrenching end 2a defines a rotational axis L2. When the high-precision digital-display torque wrench 100 is wrenched, the main body 1 rotates along the rotational axis L2 for wrenching a fastener. Therein, the rotational axis L2 is perpendicular to the axis L1.

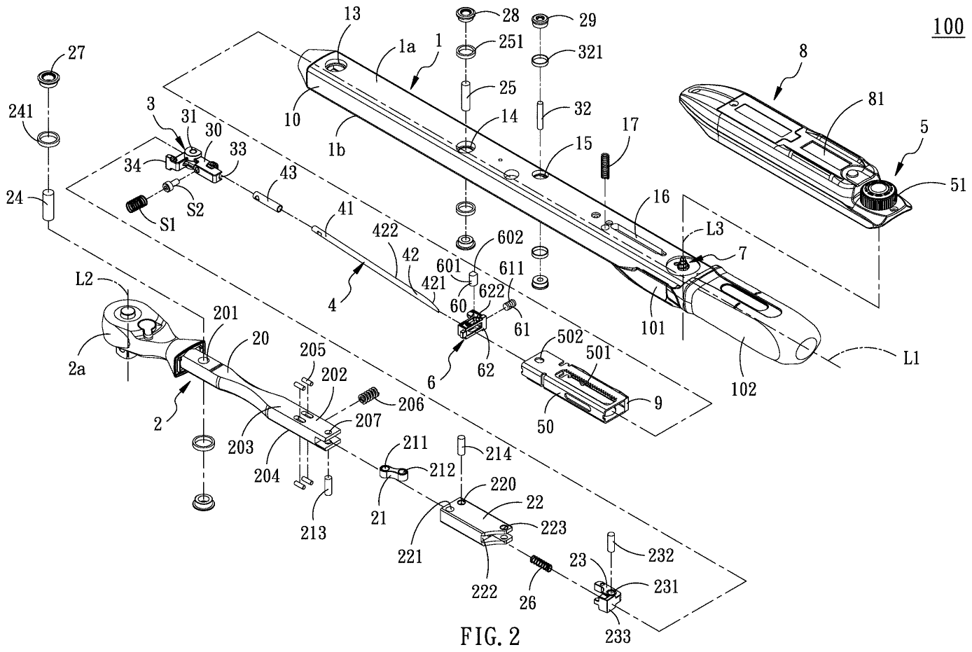

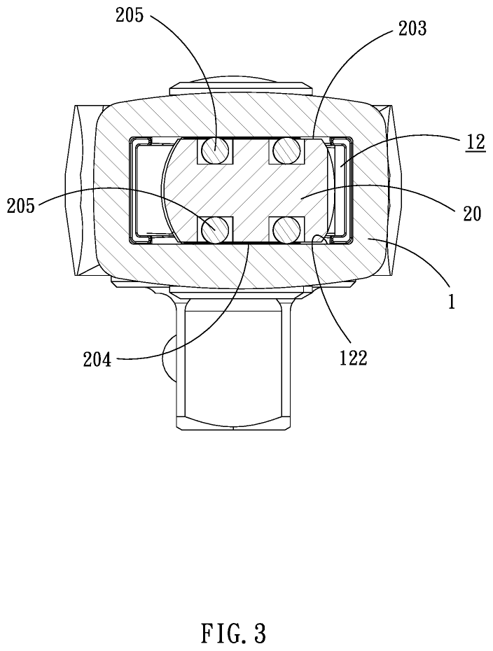

In the embodiment, the wrenching device 2 comprises a wrenching member 20, a connection bar 21, an actuation member 22, and a press member 23. The wrenching member 20 has a fourth pivot hole 201, with a first pin member 24 passing through the first pivot hole 13 and the fourth pivot hole 201, and a first bush 241 mounted around two ends of the first pin member 24, such that the wrenching member 20 is pivotally disposed at the first end 10 of the main body 1. The wrenching member 20 comprises the aforementioned wrenching end 2a and a tail end 202 inserted into the housing space 12 away from the wrenching end 2a. Referring to FIG. 2 and FIG. 3, the tail end 202 has a first face 203 and an opposite second face 204, with a contact member 205 embedded in the first face 203 and the second face 204, respectively, along the direction of the axis L1 to contact the inner wall 122. Therefore, during the operation of the high-precision digital-display torque wrench 100, the contact member 205 contacts the inner wall 122, preventing the wrenching member 20 from directly rubbing the main body 1, thereby aligning the wrenching member 20 and preventing the friction between the wrenching member 20 and the main body 1 which may cause error of the torque precision. Therein, the contact member 205 is formed in a circular rod, and each of the first face 203 and the second face 204 has two contact members 205 disposed thereon, respectively.

The wrenching member 20 has an elastic member 206 disposed on one side thereof for abutting against the first inner wall 122a, so as to provide a force to recover the wrenching member 20 to the normal status.

The connection bar 21 is pivotally disposed between the tail end 202 and the actuation member 22. The connection bar 21 has a first connection hole 211 on one end and a second connection hole 212 on the other end. Therein, a fix pin 213 passes through a through hole 207 on the tail end 202 and the first connection hole 211, so that one end of the connection bar 21 is pivotally disposed at the tail end 202. Also, a fix pin 214 passes through the second connection hole 212 and a through hole 220 of the actuation member 22, so that the other end of the connection bar 21 is pivotally disposed at the actuation member 22.

The actuation member 22 has a fifth pivot hole 221 disposed in adjacent to the through hole 220, with a second pin member 25 passing through the second pivot hole 14 and the fifth pivot hole 221, and a second bush 251 mounted around two ends of the second pin member 25, such that the actuation member 22 is pivotally disposed on the main body 1 and generates a linkage relationship with the connection bar 21. The actuation member 22 has the press member 23 pivotally disposed thereon and arranged away from the wrenching end 2a and the connection bar 21. The actuation member 22 has a stop wall 222 disposed on one side of the press member 23 for limiting the pivoting range of the press member 23.

The press member 23 has a through hole 231, with a fix pin 232 passing through a through hole 223 of the actuation member 22 and the through hole 231 of the press member 23, so as to pivot with respect to the actuation member 22. The press member 23 has a first abutting part 233.

The torque release device 3 is pivotally disposed in the housing space 12 of the main body 1 and optionally abuts against the press member 23 of the wrenching device 2 arranged away from the wrenching end 2a. In the embodiment, the torque release device 3 comprises a releasing member 30. The releasing member 30 has a sixth pivot hole 31, with a third pin member 32 passing through the third pivot hole 15 and the sixth pivot hole 31, and a third bush 321 mounted around two ends of the third pin member 32, such that the releasing member 30 is pivotally disposed on the main body 1 and abuts against the press member 23. The releasing member 30 has a fix hole 33.

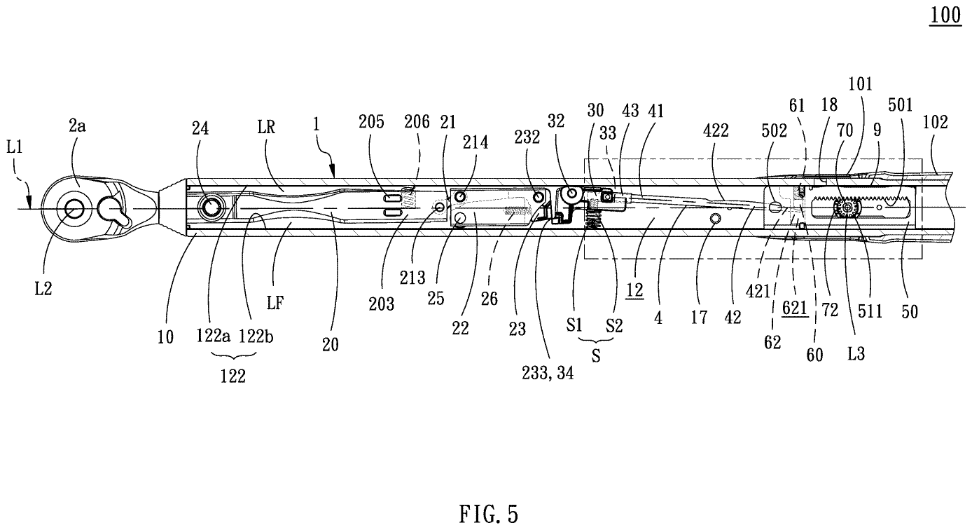

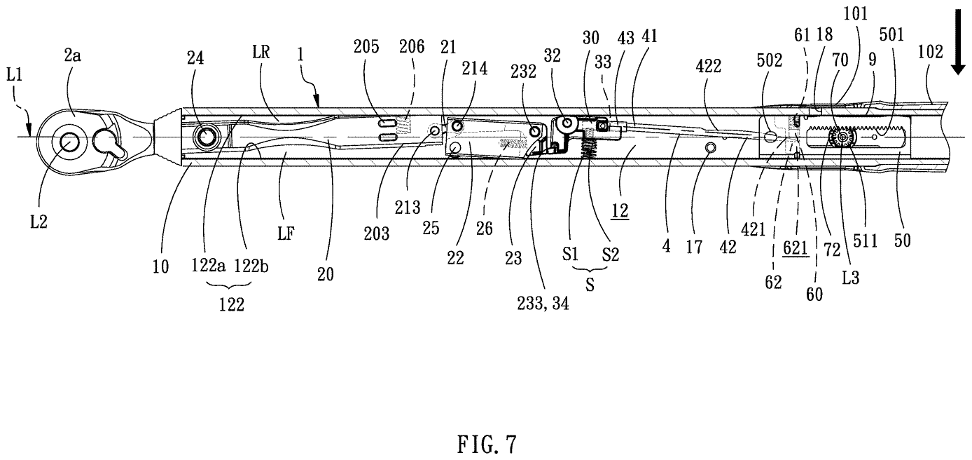

When the high-precision digital-display torque wrench 100 is wrenched and the force thereby imposed continues to increase to be equal to the torque setting value, the releasing member 30 is disengaged from the press member 23 to cut off the force imposed by the high-precision digital-display torque wrench 100 (as shown by FIG. 7). When the high-precision digital-display torque wrench 100 is restored to the normal status, the releasing member 30 and the press member 23 automatically go back to the originally abutting status (as shown by FIG. 5). In the embodiment, the releasing member 30 has a second abutting part 34 disposed on one side away from the resilient member 4 to abut against the first abutting part 233 of the press member 23. In addition, the wrenching device 2 further comprises a recover member 26 disposed between the actuation member 22 and the press member 23. The recover member 26 is a spring and normally maintains the abutting status between the press member 23 and the releasing member 30 of the torque release device 3.

In the embodiment, a first steel ring 27 is disposed between the first bush 241 and the first pivot hole 13; a second steel ring 28 is disposed between the second bush 251 and the second pivot hole 14; and a third steel ring 29 is disposed between the third bush 321 and the third pivot hole 15. The first steel ring 27, the second steel ring 28, and the third steel ring 29 prevent the first pivot hole 13, the second pivot hole 14, and the third pivot hole 15 of the main body 1 from expansion during usage, which might cause the combination instability between corresponding components and thereby result in error of the torque precision.

Referring to FIG. 2 in view of FIG. 5, the resilient member 4 is disposed in the housing space 12 in a manner of not parallel to the axis L1. In an embodiment, the resilient member 4 is a rod-shaped object with both ends formed in different shapes. The resilient member 4 is disposed in the housing space 12 and arranged inclined with respect to the axis L1. The resilient member 4 comprises a fixed end 41 and a contact section 42 away from the fixed end 41. The contact section 42 is able to cross the axis L1 of the main body 1, and the fixed end 41 is inserted into and fixed to the fix hole 33 of the releasing member 30. In the embodiment, a resistance kit 43 is disposed between the fixed end 41 and the fix hole 33. The resistance kit 43 is capable of dispersing the shear stress generated during the operation of the resilient member 4, thereby effectively increasing the service life of the resilient member 4 by more than twice.

The torque adjustment device 5 is disposed on the main body 1. The torque adjustment device 5 has a sliding seat 50 and a first transmission member 51. The sliding seat 50 is disposed in the guidance part 121 in the housing space 12 and movable along the direction parallel to the axis L1. The sliding seat 50 is formed in a frame body. The first transmission member 51 is capable of carrying the sliding seat 50 to move.

The fine adjustment device 6 is disposed on the sliding seat 50. The fine adjustment device 6 comprises a supporting member 60 on which the contact section 42 of the resilient member 4 rests and a fine adjustment member 61. The fine adjustment member 61 is configured to fine adjustably support the supporting member 60, so as to fine adjust the force with which the torque release device 3 abuts against the wrenching device 2. Moreover, when the fine adjustment member 61 increases the tilting degree of the resilient member 4 with respect to the axis L1, the force with which the releasing member 30 engages with the press member 23 is greater. When the fine adjustment component 61 decreases the tilting degree of the resilient member 4 with respect to the axis L1, the force with which the releasing member 30 engages with the press member 23 is smaller. In this way, the predetermined torque setting value is accurately calibrated.

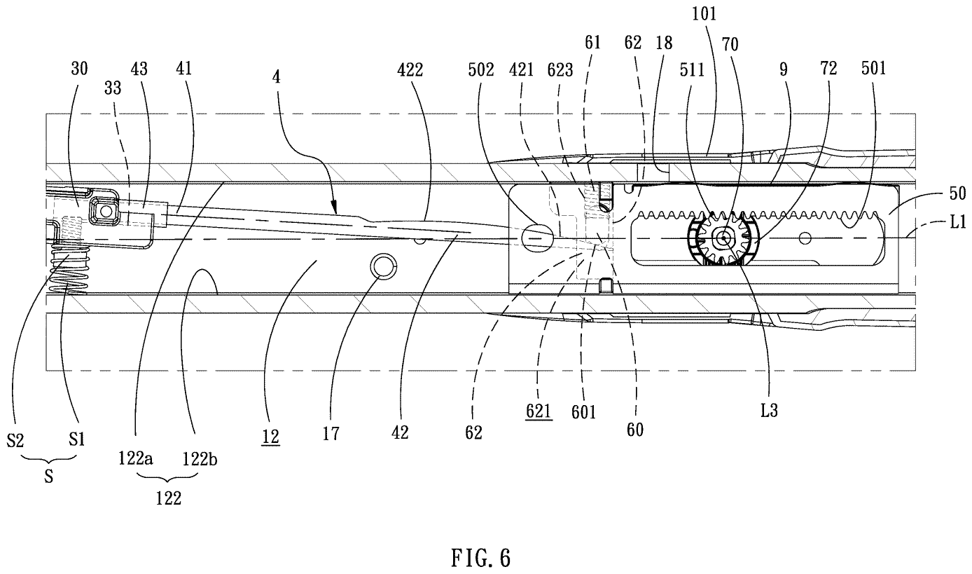

Referring to FIG. 2 in view of FIG. 5 and FIG. 6, the fine adjustment device 6 further comprises a fix seat 62 fixed in the sliding seat 50. The fix seat 62 comprises a through part 621 and a sliding groove 622 in communication with the through part 621. The contact section 42 of the resilient member 4 passes through the through part 621, and the supporting member 60 is slidably disposed in the sliding groove 622 along a direction perpendicular to the axis L1 to abut against the contact section 42. The fix seat 62 further comprises a thread hole 623 in communication with the through part 621 and the sliding groove 622. The supporting member 60 has an arc abutting face 601 contacting the contact section 42 and an opposite plane 602 abutted by the fine adjustment member 61. The fine adjustment member 61 has a thread part 611 screwed to the thread hole 623, such that the fine adjustment member 61 has one end rotatably disposed on the fix seat 62 and the other end abutting against the plane 602 of the supporting member 60. Therefore, when the fine adjustment member 61 forces the supporting member 60 to move, the contact force with which the second abutting part 34 of the releasing member 30 abuts against the first abutting part 233 of the press member 23 changes, so as to adjust the torque setting value precision of the high-precision digital-display torque wrench 100. Further, the main body 1 has an adjustment hole 18 disposed on one side thereof and in communication with the housing space 12. When the fine adjustment member 61 is in alignment with the adjustment hole 18, a tool is allowed to be inserted into the housing space 12, whereby the fine adjustment member 61 is rotationally adjusted. Because the fine adjustment device 6 is disposed away from the torque release device 3, the fine adjustment device 6 is prevented from directly bearing the counterforce of the high-precision digital-display torque wrench 100 and damaged, thereby increasing the service life thereof.

In an embodiment, the housing space 12 has a stopper 17 disposed on the movement path of the sliding seat 50. The stopper 17 is an elastic body. Therein, the stopper 17 is fixed to the main body 1 along the direction perpendicular to the axis L1. The contact section 42 of the resilient member 4 is formed in a shape where thicknesses at both ends are thinner than the thickness in the middle part thereof, which makes the torque/distance curve of the high-precision digital-display torque wrench 100 to present an almost straight-line performance, facilitating the increasing of the torque precision. The contact section 42 has a first curve contact position 421 and a second curve contact position 422 on both ends thereof. When the sliding seat 50 moves away from the stopper 17 for the supporting member 60 to abut against the first curve contact position 421, the torque setting value is at its minimum; when the sliding seat 50 moves toward to contact the stopper 17 for the supporting member 60 to abut against the second curve contact position 422, the torque setting value is at its maximum. Therein, the stopper 17 prevents the sliding seat 50 to generate unnecessary displacement when the present disclosure is during a large torque operation, thereby achieving a high-precision torque performance.

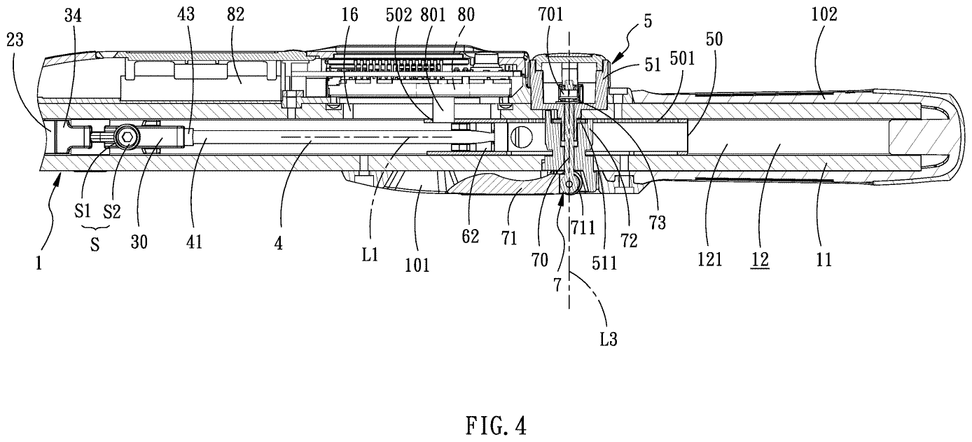

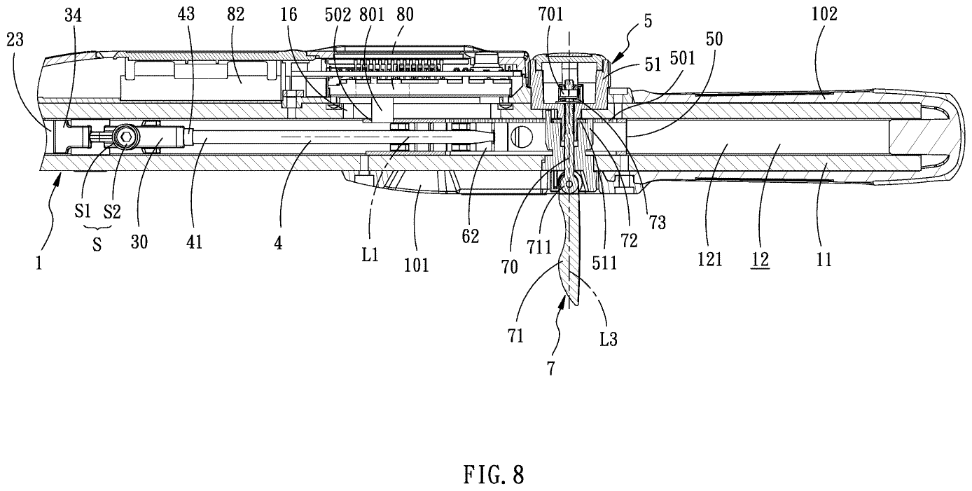

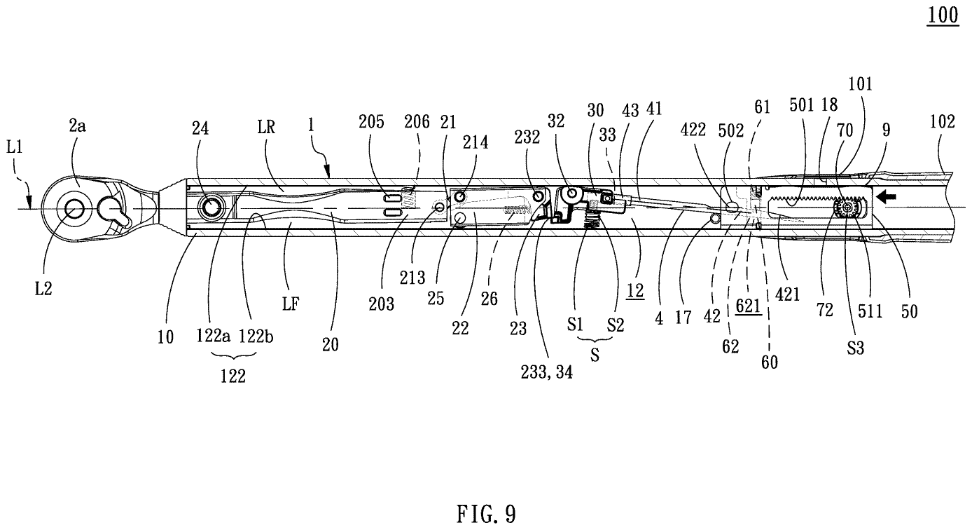

The lock device 7 is disposed between the sliding seat 50 and the main body 1, and switchable between an unlocked position and a locked position. Referring to FIG. 8 and FIG. 9 in view of FIG. 2, at the unlocked position, the user is able to perform a rotational operation along an operation axis L3 which is parallel to the rotation axis L2 and perpendicular to the axis L1, whereby the sliding seat 50 carries the supporting member 60 to move with respect to the resilient member 4. Referring to FIG. 4 and FIG. 5 in view of FIG. 2, at the locked position, the lock device 7 provides a frictional resistance between the sliding seat 50 and the main body 1, so as to clamp the main body 1 and the sliding seat 50 and tighten the combination structure thereof, thereby preventing minor movement during the force imposing process of the wrench, increasing the precision of the torque performance and preventing the distortion of the torque.

In the embodiment, the main body 1 has a top side la and an opposite bottom side 1b defined along the direction of the operation axis L3. The lock device 7 comprises a shaft 70 passing through the main body 1 and the sliding seat 50 along the operation axis L3, an operation handle 71 pivotally disposed at one end of the shaft 70, and a second transmission member 72 disposed on the shaft 70. The shaft 70 is exposed out of the main body 1 from the bottom side 1b, allowing the operation handle 71 to be pivotally disposed thereon.

The operation handle 71 has an eccentric cam 711 pivotally disposed at an end part of the shaft 70, allowing the user to optionally use the operation handle 71 to perform a pivotal operation with respect to the shaft 70, whereby the operation handle 71 drives the shaft 70 to move along the operation axis L3.

The sliding seat 50 has a first tooth part 501 disposed along the direction parallel to the axis L1, and an insertion hole 502 disposed away from the first tooth part 501. The first transmission member 51 has a second tooth part 511 disposed thereof around the operation axis L3. The second tooth part 511 is engaged with the first tooth part 501. Therein, the first transmission member 51 and the second transmission member 72 are slidably combined, through which the shaft 70 passes.

Also, at the locked position, the operation handle 71 pulls the shaft 70 along the direction of the operation axis L3, and the first transmission member 51 and the second transmission member 72 press toward each other, so that the first transmission member 51 presses the main body 1 and the second transmission member 72 is imposed with a force by the eccentric cam 711 to press the sliding seat 50, thereby clamping the main body 1 and the sliding seat 50. At the unlocked position, the operation handle 71 is relatively relaxed with respect to the shaft 70, allowing the user to rotationally operate the first transmission member 51 for driving the sliding seat 50 to linearly slide with respect to the main body 1, achieving a quick adjustment of the upper limit and the lower limit of the torque setting value.

In addition, the shaft 70 has a screw member 701 disposed on the end thereof passing through the first transmission member 51, with a spring 73 arranged between the screw member 701 and the first transmission member 51, so that the spring 73 provides a vibration absorption effect. In the embodiment, a biasing spring leaf 9 is embedded on a lateral side of the sliding seat 50 to abut against the inner wall 122 of the housing space 12, so as to eliminate the gap between the sliding seat 50 and the main body 1.

Referring to FIG. 7 in view of FIG. 2, when the force imposed by wrenching the high-precision digital-display torque wrench 100 increases to be equal to the torque setting value, the releasing member 30 is disengaged from the press member 23 to cut off the force imposing of the high-precision digital-display torque wrench 100, and the actuation member 22 carries the connection bar 21 to move together with respect to the main body 1, causing the wrenching member 20 to hit the first inner wall 122a and the actuation member 22 to hit the second inner wall 122b. When the high-precision digital-display torque wrench 100 is recovered to the normal status, the releasing member 30 is automatically restored to be engaged with the press member 23. Therefore, during the wrenching operation, the user is able to feel an obvious mechanical torque disengagement sensation, which effectively reminds the user to stop imposing the wrenching force.

The torque sensing device 8 is disposed on the main body 1 corresponding to the torque adjustment device 5. The torque sensing device 8 displays a torque setting value according to a displacement change of the sliding seat 50. The torque sensing device 8 comprises a sensing member 80, a display 81 electrically connected with the sensing member 80, and a battery 82 electrically connected with the sensing member 80 and the display 81. The sensing member 80 is a variable resistor and has a movable part 801. The movable part 801 is disposed in the insertion hole 502 of the sliding seat 50 and moves along with it. The sensing member 80 generates a torque signal by sensing the displacement change of the sliding seat 50 through the sensing hole 16, and the display 81 displays the torque setting value according to the torque signal.

In the embodiment, a protection cover 101 is disposed on the bottom side 1b to cover the periphery of the operation handle 71, preventing the operation handle 71 from being externally and accidentally touched to pivot. The main body 1 further comprises a handgrip 102 connected with the protection cover 101 and mounted around the second end 11 of the main body 1. Therein, after the product leaves the factory, the protection cover 101 is configured to cover the aforementioned adjustment hole 18.

The present disclosure further comprises an elastic device S, comprising a spring S1 and a bolt S2. The bolt S2 is screwed to the releasing member 30 and abuts against the resistance kit 43. The spring S1 has one end connected with the bolt S2 and the other end abutting against the second inner wall 122b of the inner wall 122. The spring S1 keeps the contact section 42 of the resilient member 4 to contact the supporting member 60.

With the foregoing configuration, advantages of the present disclosure will be illustrated below.

The present disclosure uses the fine adjustment device 6 to fine adjust the force with which the releasing device 3 abuts against the wrenching device 2, so as to fine adjust the force with which the releasing member 30 abuts against the press member 23, thereby adjusting the precision of the torque setting value of the high-precision digital-display torque wrench 100, ensuring that the variation of the torque setting value of the high-precision digital-display torque wrench 100 is within a low error range.

When the torque setting value is at its maximum, the stopper 17 limits the displacement of the sliding seat 50, such that the sliding seat 50 is prevented from displacement during the large torque operation, so as to achieve a high-precision torque performance.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A high-precision digital-display torque wrench in accordance with the present disclosure, comprising:
a main body having a first end and a second end away from the first end arranged along an axis, with a housing space formed between the first end and the second end;
a wrenching device pivotally disposed at the first end and having a wrenching end exposed from the main body;
a torque release device pivotally disposed in the housing space and optionally abutting against one end of the wrenching device away from the wrenching end;
a resilient member disposed in the housing space in a manner not parallel to the axis, the resilient member having a fixed end and a contact section away from the fixed end, the fixed end fixed to the torque release device;
a torque adjustment device disposed on the main body and having a sliding seat, the sliding seat disposed in the housing space and slidably movable along a direction parallel to the axis;
a fine adjustment device disposed on the sliding seat, the fine adjustment device having a supporting member on which the contact section of the resilient member rests and a fine adjustment member, the fine adjustment member fine adjustably supporting the supporting member, so as to fine adjust a force with which the torque release device rests on the wrenching device; and
a torque sensing device disposed on the main body corresponding to the torque adjustment device, the torque sensing device displaying a torque setting value according to a displacement change of the sliding seat.

2. The high-precision digital-display torque wrench of claim 1, wherein the fine adjustment device comprises a fix seat fixed in the sliding seat; the fix seat comprises a through part and a sliding groove in communication with the through part;
the contact section passes through the through part, and the supporting member is slidably disposed in the sliding groove along a direction perpendicular to the axis to abut against the contact section; the fine adjustment member has one end rotatably disposed on the fix seat and another end abutting against the supporting member.

3. The high-precision digital-display torque wrench of claim 2, wherein the fix seat comprises a thread hole in communication with the through part and the sliding groove; the fine adjustment member has a thread part screwed to the thread hole; the supporting member has an arc abutting face contacting the contact section and an opposite plane abutted by the fine adjustment member; the main body has an adjustment hole disposed on one side thereof and in communication with the housing space; when the fine adjustment member is in alignment with the adjustment hole, the fine adjustment member is rotationally adjusted.

4. The high-precision digital-display torque wrench of claim 1, wherein the housing space has a stopper disposed on a movement path of the sliding seat; the resilient member is a rod-shaped object with both ends formed in different shapes; the contact section is formed in a shape where thicknesses at both ends thereof are thinner than a thickness in a middle part thereof; the contact section has a first curve contact position and a second curve contact position on both ends thereof; when the sliding seat moves away from the stopper for the supporting member to abut against the first curve contact position, the torque setting value is at its minimum; when the sliding seat moves toward to contact the stopper for the supporting member to abut against the second curve contact position, the torque setting value is at its maximum.

5. The high-precision digital-display torque wrench of claim 4, wherein the stopper is an elastic body; the stopper is fixed to the main body along a direction perpendicular to the axis.

6. The high-precision digital-display torque wrench of claim 1, wherein the wrenching device has a press member disposed away from the wrenching end; the torque release device comprises a releasing member; the releasing member is pivotally disposed on the main body and abuts against the press member; the releasing member has a fix hole through which the fixed end passes, with a resistance kit disposed between the fixed end and the fix hole.

7. The high-precision digital-display torque wrench of claim 6, wherein the wrenching device comprises a wrenching member, a connection bar, and an actuation member; the wrenching member is pivotally disposed at the first end, and comprises the wrenching end and a tail end inserted into the housing space; the connection bar is pivotally disposed between the tail end and the actuation member; the actuation member is pivotally disposed on the main body, and generates a linkage relationship with the connection bar; the actuation member has the press member pivotally disposed thereon and arranged away from the connection bar; the main body has an inner wall; the tail end comprises a first face and a second face disposed in opposite to the first face, with a contact member embedded in the first face and the second face, respectively, along the direction of the axis to contact the inner wall; an elastic device is included, and comprises a spring and a bolt; the bolt is screwed to the releasing member and abuts against the resistance kit; the spring has one end connected with the bolt and another end abutting against the inner wall; the spring keeps the contact section of the resilient member to contact the supporting member.

8. The high-precision digital-display torque wrench of claim 7, wherein the contact member is formed in a circular rod;
the main body is formed of an aluminum alloy material; the main body comprises a first pivot hole, a second pivot hole, and a third pivot hole sequentially disposed thereon from the first end toward the second end; the wrenching member has a fourth pivot hole, with a first pin member passing through the first pivot hole and the fourth pivot hole, and a first bush mounted around two ends of the first pin member; the actuation member has a fifth pivot hole, with a second pin member passing through the second pivot hole and the fifth pivot hole, and a second bush mounted around two ends of the second pin member; the releasing member has a sixth pivot hole, with a third pin member passing through the third pivot hole and the sixth pivot hole, and a third bush mounted around two ends of the third pin member; a first steel ring is disposed between the first bush and the first pivot hole; a second steel ring is disposed between the second bush and the second pivot hole; and a third steel ring is disposed between the third bush and the third pivot hole.

9. The high-precision digital-display torque wrench of claim 2, wherein the wrenching end defines a rotational axis, such that during a wrenching operation, the main body rotates along the rotational axis; the wrenching device has a press member disposed away from the wrenching end; the press member has a first abutting part; the torque release device comprises a releasing member; the releasing member is pivotally disposed on the main body and abuts against the press member; the releasing member has a second abutting part disposed on one side away from the resilient member to abut against the first abutting part; when the fine adjustment member forces the supporting member to move, a contact force with which the second abutting part abuts against the first abutting part changes; a lock device is disposed between the sliding seat and the main body, and switchable between an unlocked position and a locked position; at the unlocked position, the high-precision digital-display torque wrench is rotationally operated along an operation axis which is parallel to the rotation axis and perpendicular to the axis, whereby the sliding seat carries the supporting member to move with respect to the resilient member; at the locked position, the lock device clamps the main body and the sliding seat, preventing the sliding seat to move with respect to the main body.

10. The high-precision digital-display torque wrench of claim 9, wherein the main body has a top side and an opposite bottom side defined along a direction of the operation axis; the sliding seat has a first tooth part disposed along the direction parallel to the axis; the torque adjustment device comprises a first transmission member which carries the sliding seat to move; the first transmission member has a second tooth part disposed thereof around the operation axis; the second tooth part is engaged with the first tooth part; the lock device comprises a shaft passing through the main body and the sliding seat along the operation axis, an operation handle pivotally disposed at one end of the shaft, and a second transmission member disposed on the shaft; the shaft is exposed out of the main body from the bottom side for the operation handle to be pivotally disposed thereon; the operation handle has an eccentric cam pivotally disposed at an end part of the shaft, so that the operation handle is optionally used to perform a pivotal operation with respect to the shaft, whereby the operation handle drives the shaft to move along the operation axis; the first transmission member and the second transmission member are slidably combined through which the shaft passes; at the locked position, the operation handle pulls the shaft along the direction of the operation axis, and the first transmission member and the second transmission member press toward each other, so that the first transmission member presses the main body and the second transmission member is imposed with a force by the eccentric cam to press the sliding seat, thereby clamping the main body and the sliding seat; at the unlocked position, the operation handle is relaxed with respect to the shaft, so that the first transmission member is rotationally operated for driving the sliding seat to linearly slide with respect to the main body; the shaft has one end screwed to the first transmission member, and a screw member is disposed on the shaft, with a spring disposed between the screw member and the first transmission member; a biasing spring leaf is embedded on a lateral side of the sliding seat to abut against an inner wall of the housing space; the axis divides the main body into a forward side and a reverse side; the inner wall comprises a first inner wall on the reverse side and a second inner wall on the forward side; the wrenching device comprises a wrenching member, a connection bar, and an actuation member; the wrenching member is pivotally disposed at the first end and comprises the wrenching end and a tail end inserted into the housing space; the connection bar is pivotally disposed between the tail end and the actuation member; the actuation member is pivotally disposed on the main body, and generates a linkage relationship with the connection bar; the actuation member has the press member pivotally disposed thereon and arranged away from the connection bar; when a force imposed by the high-precision digital-display torque wrench being wrenched reaches to be equal to the torque setting value, the releasing member is disengaged from the press member to cut off a force imposing of the high-precision digital-display torque wrench, and the actuation member carries the connection bar to move together with respect to the main body, causing the wrenching member to hit the first inner wall and causing the actuation member to hit the second inner wall; when the high-precision digital-display torque wrench is recovered to a normal status, the releasing member is automatically restored to be engaged with the press member; a recover member is disposed between the actuation member and the press member, and normally keeps the press member to be engaged with the releasing member; an elastic member is disposed on one side of the wrenching member to abut against the first inner wall, so as to provide a force to recover the wrenching member to a normal status; the main body has an elongate sensing hole disposed in adjacent to the second end and in communication with the housing space; the torque sensing device comprises a sensing member, a display electrically connected with the sensing member, and a battery electrically connected with the sensing member and the display; the sensing member is a variable resistor and has a movable part; the movable part is disposed on the sliding seat and moves along with it; the sensing member generates a torque signal by sensing the displacement change of the sliding seat through the sensing hole, and the display displays the torque setting value according to the torque signal; a protection cover is disposed on the bottom side to cover a periphery of the operation handle; the main body comprises a handgrip connected with the protection cover and mounted around the second end.
